(19) United States
(12) Patent Application Publication
(10) Pub. No.: US 2010/0137476 A1
(43) Pub. Date: Jun. 3, 2010

(54) DISPERSANT FOR PLASTER COMPOSITIONS

(75) Inventors: Ueli Sulser, Unterengstringen (CH); Burkhard Mueller, Ditzingen-Heimerdingen (DE); Christina Hampel, Oberengstringen (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/451,660

(22) PCT Filed: Jun. 11, 2008
(86) PCT No.: PCT/EP2008/057249

§ 371 Date: Dec. 2, 2009

(30) Foreign Application Priority Data
Jun. 11, 2007 (EP) 07109997.2

(51) Int. Cl. C04B 24/28

(52) U.S. Cl. 524/5

(57) ABSTRACT

The present invention relates to the use of a polymer P as a dispersant, particularly as a liquefier, for plaster compositions as well as plaster compositions comprising the polymer P. The polymer P comprises at least one acid unit, at least one ester unit, and at least one amide unit, and the ratio of the acid units to the ester and amide units is between 2 and 6.

### FIELD OF THE INVENTION

The invention relates to the field of gypsum compositions, in particular of dispersants for gypsum compositions.

### PRIOR ART

Polymers of α,β-unsaturated carboxylic acids having polyalkylene glycol side chains have been used for a relatively long time as dispersants, in particular as plasticizers, in concrete technology, owing to their considerable water reduction. These polymers have a comb polymer structure. There is a number of such comb polymers which also have amide groups in addition to ester and carboxylic acid groups.

It has now been found that the known concrete dispersants can be used only to a limited extent for gypsum compositions. The known concrete dispersants either achieve only relatively little plasticization in gypsum and must therefore be used in high doses or they have such a strong retardant effect that the gypsum composition scarcely sets.

For example, melamine-sulfonic acid-formaldehyde condensates have been used to date as gypsum plasticizers. These plasticizers are, however, ecologically problematic owing to the release of toxic formaldehyde and are therefore not desired. Other known gypsum plasticizers are based on lignin- or naphthalenesulfonates, as described, for example, in WO02081400A1. Such plasticizers have the disadvantage that the gypsum compositions prepared therewith become discolored.

### SUMMARY OF THE INVENTION

It is therefore an object of the present invention to provide dispersants with which the disadvantages of the prior art are overcome and which are suitable for achieving a sufficient plasticizing effect of gypsum compositions without having too great a retardant effect.

Surprisingly, it was found that this can be achieved by the use of a polymer P as claimed in claim 1. It has now surprisingly been found that a particularly good plasticizing effect in gypsum compositions can be achieved with polymers which have a ratio of the carboxylic acid units to the ester/amide units of from 2 to 6. Furthermore, it has been found that these polymers can be used for water reduction of gypsum compositions and that they lead to a longer processing time without having too great a retardant effect on the setting. Moreover, gypsum compositions comprising the polymers used according to the invention show substantially less shrinkage and swelling behavior than those prepared with conventional gypsum plasticizers. Likewise, compositions which do not become discolored are possible with these polymers.

The invention also comprises binder-containing mixtures comprising gypsum and at least one polymer P which has a ratio of the carboxylic acid units to the ester/amide units of from 2 to 6, and the preparation of such binder-containing mixtures. Further advantageous configurations of the invention are evident from the subclaims.

### PREFERRED EMBODIMENTS OF THE INVENTION

The invention relates to the use of a polymer P as a dispersant for gypsum compositions.

The dispersant can be used in particular as a plasticizer, as a water reducer or for improving the processability and the flowability of the gypsum compositions prepared therewith.

In a particularly preferred use, the polymer P is used as a plasticizer for gypsum compositions.

“Gypsum composition” is understood as meaning a composition which contains at least 30% by weight, preferably at least 50% by weight, more preferably at least 80% by weight or 100% by weight of gypsum, based on the total weight of the binder. In a preferred application, the gypsum composition is cement-free. Gypsum compositions are understood as meaning in particular compositions which predominantly contain sulfate binders. Examples of such gypsum compositions are:
flowable anhydrite screed (FAS) based on natural, chemical and REA anhydrite and calcium sulfate α-hemihydrate,
filling compounds based on calcium sulfate α-hemihydrate which are rendered alkaline or neutral,
plaster of Paris and molding plasters, such as casting gypsum, turning gypsum, hard compression molding gypsum, die casting gypsum and gypsum for producing master molds,
gypsum compositions based on calcium sulfate β-hemihydrate as used, for example, for the production of sandwich-type plasterboards.

The term “binder” covers not only gypsum but also further hydraulically setting substances, such as, for example, cement, in particular Portland cements or high-alumina cements and respectively mixtures thereof with fly ashes, silica fume, slag, blast furnace sands and limestone filler or quicklime.

The term “gypsum” includes any known form of gypsum, in particular calcium sulfate dihydrate, calcium sulfate α-hemihydrate, calcium sulfate β-hemihydrate and calcium sulfate anhydrite.

The polymer P which is suitable according to the invention in particular for use as a dispersant, in particular as a plasticizer, for gypsum compositions comprises:

a) m mol % of at least one structural unit A of the formula (I);

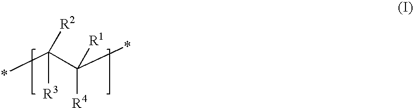

b) n mol % of at least one structural unit B of the formula (II);

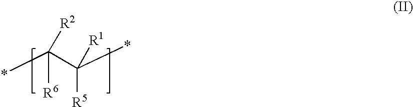

c) o mol % of at least one structural unit C of the formula (III);

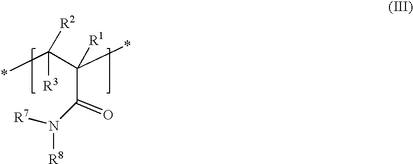

and optionally

d) p mol % of at least one further structural unit D.

Here, R¹, independently of one another, is H, CH₂COOM or an alkyl group having 1 to 5 carbon atoms and R², independently of one another, is H, an alkyl group having 1 to 5 carbon atoms, COOM or CH₂COOM.

R³, independently of one another, may be H, CH₃, COOM or CH₂COOM and R⁴ is COOM, or R³ and R⁴ may form a ring to give —CO—O—CO—.

M is H, a C₁-C₅-alkyl radical, alkali metal, alkaline earth metal, ammonium, ammonium cation or mixtures thereof.

R⁵, independently of one another, is

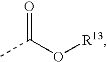

in which R¹³ is —[(R⁹O)ₓ—(R¹⁰O)_{y}—(R¹¹—O)_{z}]—R¹², and R¹¹, each independently of one another, is a C₂-C₄-alkylene group having an order of the (R⁹O), (R¹⁰O) and (R¹¹O) units in any possible sequence. R¹² is H, a C₁-C₁₂-alkyl or cycloalkyl radical, a C₇-C₂₀-alkylaryl or aralkyl radical or a substituted or unsubstituted aryl radical, and x, y and z, independently of one another, each have the values 0-250 and x+y+z=3-250.

R⁶, independently of one another, is H, CH₃, COOM, CH₂COOM or a substituent as defined for R⁵.

R⁷ and R⁸ together may form a ring which optionally contains oxygen, sulfur or further nitrogen atoms, or R⁷ and R⁸, independently of one another, are H, a C₁-C₂₀-alkyl group, a C₅-C₉-cycloalkyl group, a C₇-C₁₂-aralkyl group, a hydroxyalkyl group or a compound of the formula (IV), (V) or (VI),

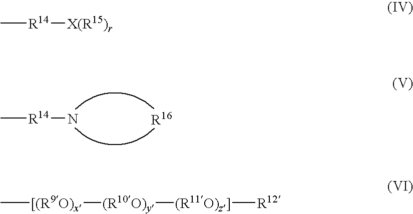

in which R¹⁴, independently of one another, is an alkylene group and R¹⁵ is a C₁- to C₄-alkyl group and X, independently of one another, is an S, O or N, where r=1 if X═S or O, or r=2 if X═N, in which R¹⁶ is an alkylene group having optionally heteroatoms and, together with the nitrogen atom, forms a 5-membered to 8-membered ring, in particular a 6-membered ring, and in which R^{9′}, R^{10′} and R^{11′}, each independently of one another, is a C₂-C₄-alkylene group having an order of the (R^{9′}O), (R^{10′}O) and (R^{11′}O) units in any possible sequence and R^{12′} is a C₁-C₁₂-alkyl or cycloalkyl radical, a C₇-C₂₀-alkylaryl or aralkyl radical, or a substituted or unsubstituted aryl radical. R⁷ may be both radicals as defined for R^{7′} in the formula (VIII) and radicals as defined for R^{7″} in the formula (VIII′). Likewise, R⁸ may be both radicals as defined for R^{8′} in formula (VIII) and radicals as defined for R^{8″} in the formula (VIII′).

The indices x′, y′ and z′, independently of one another, each have the values 0-100 and x′+y′+z′=1-100.

Here, m, n, o and p, independently of one another, are numbers, whereby m+n+o+p=100 and m>0, n>0, o>0 and p≧0. The ratio m/(n+o+p) is from 2 to 6.

Preferably, m is a number from 50 to 95, preferably 66-86, n is a number from 5 to 50, preferably 14-34, o is a number from 0.001 to 30, preferably 0.01-1, and p is a number from 0 to 30, preferably 0-1.

It has been found that a surprisingly good plasticizing effect is achieved in gypsum compositions if the polymer P has a ratio of the acid units (A) to the remaining units (B, C, D), i.e. in particular to ester and amide units, of from 2 to 6.

The ratio m/(n+o+p) is the ratio of all carboxylic acid units A to the ester units (B) and amide units (C) and optionally further units of the structural unit D in the polymer P. Particularly good results are obtained if this ratio is from 2.5 to 5.0, in particular from 2.70 to 3.98.

M may be a cation, in particular H⁺, Na⁺⁺, Ca⁺⁺/2, Mg⁺⁺/2, NH₄⁺ or an organic ammonium. It is clear to the person skilled in the art that, in the case of the polyvalent ions, a further counterion must be present, which may also be, inter alia, a carboxylate thereof or of another molecule of the polymer P. The ammonium compounds are in particular tetraalkylammonium or HR₃N⁺, in which R is an alkyl group, in particular a C₁- to C₆-alkyl group, preferably ethyl or butyl. Ammonium ions are obtained in particular by the neutralization of the carboxyl group with commercially available tertiary amines.

In a preferred embodiment, in the polymer P, the radical R¹ is H or CH₃ and the radicals R², R³ and M, as well as preferably R⁶, are H.

The structural unit A of the formula (I) is therefore preferably a methacrylic acid unit or an acrylic acid unit or analogs thereof.

In the polymer P, the order of (R⁹O), (R¹⁰O) and (R¹¹O) is preferably random, alternating or blockwise for R¹³, and (R⁹O)≠(R¹⁰O)≠(R¹¹O). Preferably, R⁹, independently of one another, is a C₂-alkylene group, R¹⁰, independently of one another, is a C₃-alkylene group and R¹¹, independently of one another, is a C₄-alkylene group.

In the case of a preferred polymer P, at least 30 mol %, particularly preferably 50-100 mol %, more preferably 80-100 mol %, most preferably 100 mol %, of the structural unit B of the formula (II) are represented by a structure in which R⁹ is a C₂-alkylene group and y=0 and z=0. This means that R¹³ preferably comprises at least 30 mol % of (R⁹O) units, preferably from 50 to 100 mol % of (R⁹O) units, more preferably from 80 to 100 mol % of (R⁹O) units, based on the total molar amount of all (R⁹O), (R¹⁰O) and (R¹¹O) units. Particularly preferably R¹³ comprises 100 mol % of (R⁹O) units, based on the total molar amount of all (R⁹O), (R¹⁰O) and (R¹¹O) units. Depending on the process for the preparation of the polymer P, R¹² may be H, a C₁-C₁₂-alkyl or cycloalkyl radical, a C₇-C₂₀-alkylaryl or aralkyl radical, or a substituted or unsubstituted aryl radical. If the polymer P is prepared via a polymer-analogous reaction, R¹² is preferably R^{12″}, in particular a methyl radical, and is not a hydrogen atom.

The radicals R^{9′}, R^{10′} and R^{11′} or (R^{9′}O), (R^{10′}O) and (R^{11′}O), independently of one another, are substituents as defined for R⁹, R¹⁰ and R¹¹ or for (R⁹O) , (R¹⁰O) and (R¹¹O) respectively.

In the case of a preferred polymer P, the structural unit C of the formula (III) is represented by a structure in which R⁷ is H and R⁸ is a compound of the formula (VI), in which z=0, R^{9′} is a C₂-alkylene group and R^{10′} is a C₃-alkylene group. This means that R⁸ preferably comprises at least 30 mol % of (R^{9′}O) units, preferably from 50 to 80 mol % of (R^{9′}O) units, more preferably from 60 to 80 mol % of (R^{9′}O) units, and at least 10 mol % of (R^{10′}O) units, preferably from 20 to 50 mol % of (R^{10′}O) units, more preferably from 20 to 40 mol % of (R^{10′}O) units, based on the total amount of all (R^{9′}O) and (R^{10′}O) units. Particularly preferably, R⁸ comprises at least 70 mol % of (R^{9′}O) units and not more than 30 mol % of (R^{10′}O) units, based on the total molar amount of all (R^{9′}O), (R^{10′}O) and (R^{11′}O) units.

The further structural unit D may be a further amide or ester unit. For example, the structural unit D may be an ester unit which is prepared by reacting a mono- or dicarboxylic acid with an alkyl alcohol, in particular a C₆-C₂₀-alkyl alcohol.

A particularly preferred polymer P comprises or consists of

a) m mol % of at least one structural unit A of the formula (I′);

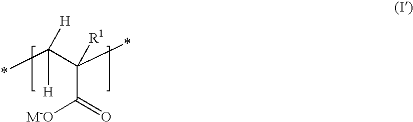

b) n mol % of at least one structural unit B of the formula (II′);

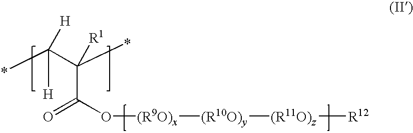

and

c) o mol % of at least one structural unit C of the formula (III′);

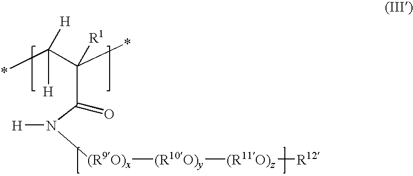

in which R¹ is H or an alkyl radical, preferably a methyl radical,

in which M is an H⁺, Na⁺, Ca⁺⁺/2, Mg⁺⁺/2, NH₄⁺ or an organic ammonium, preferably an H⁺,

in which R⁹ and R^{9′} are an ethylene group,

in which R¹⁰ and R^{10′} are a propylene group,

in which R¹¹ and R^{11′} are a butylene group,

in which R¹² is a C₁- to C₁₂-alkyl group, preferably a methyl group,

in which x is 1-250, preferably from 10 to 100, in which y is 0-250, preferably from 0 to 50, in which z is from 0 to 100, preferably 0, and

in which m is a number from 50 to 95, preferably 66-86, n is a number from 5 to 50, preferably 14-34, and o is a number from 0.001 to 30, preferably 0.01-1.

The polymer P may have a combination of different structural units of the respective structural units of A, B, C and D. For example, a plurality of structural units A can occur as a mixture in the polymer P, for example a mixture of methacrylic acid units with acrylic acid units. Alternatively, a plurality of ester units B may occur as a mixture in the polymer P, for example a plurality of ester units B having different substituents R¹³. For example, the joint use of polyalkylene glycols, in particular of polyethylene glycols with polypropylene glycols, or the joint use of polyalkylene glycols, in particular of polyethylene glycols, having different molecular weight is preferred. A plurality of amide units C may also be present in the polymer P, in particular the combination of at least one unit C having R^{7′} and R^{8′} as radicals R⁷ and R⁸ with at least one unit C having R^{7″} and R^{8″} as radicals R⁷ and R⁸.

In a preferred embodiment, the polymer P comprises from 50 to 95 mol %, preferably from 66 to 86 mol %, of the structural unit A of the formula (I), from 5 to 50 mol %, preferably from 14 to 34 mol %, of the structural unit B of the formula (II), from 0.001 to 30 mol %, preferably from 0.01 to 1 mol %, particularly preferably from 0.1 to 1 mol %, of the structural unit C of the formula (III), and optionally from 0 to 30 mol %, preferably from 0 to 1 mol %, of the structural unit D, based in each case on the total molar amount of the structural units of A, B, C and D in the polymer P.

The sequence of the individual structural units A, B, C and D in the polymer P may be blockwise or random.

The polymer P preferably has a molecular weight in the range of 1000-150 000 g/mol, preferably 10 000-100 000 g/mol, preferably 30 000-80 000 g/mol, particularly preferably 40 000-70 000 g/mol.

The polymer P can be prepared in various ways. Substantially three processes are used. In a first process, the polymers are prepared in a so-called polymer-analogous reaction from a polycarboxy polymer and the respective alcohols and amines. In a second process, anhydride groups are also formed in addition to ester and possibly amide groups in the polymer-analogous reaction in the first step, and the anhydride groups formed in the first step are reacted with an amine compound to give an amide in a second step. In a third process, the polymers are prepared from the respective unsaturated carboxylic acid-, ester- and amide-functional monomers by free radical polymerization.

Particularly preferred polymers are prepared by the polymer-analogous reaction according to the first process. The polymer-analogous reaction has the major advantage that very different comb polymers having very different properties can be obtained in a simple and reliable manner from commercially available polymers of α,β-unsaturated mono- or dicarboxylic acids, especially of poly(meth)acrylic acids, by variation of the amount, of the type and of the ratio of alcohol to amine. Such polymer-analogous reactions are described, for example, in WO97/35814A1, WO95/09821A2, DE 100 15 135A1, EP 1138697A1 and EP1348729A1. Details of the polymer-analogous reaction are disclosed, for example, in EP 1 138 697 B1, on page 7, line 20 to page 8, line 50, and in examples thereof, or in EP 1 061 089 B1, on page 4, line 54 to page 5, line 38, and in examples thereof. Polymer P can also be obtained in a solid state of aggregation, as described in EP 1 348 729 A1, on page 3 to page 5 and in examples thereof.

A polymer P is thus preferably used, the polymer P being obtainable by the reaction of

(a) at least one polycarboxylic acid or an analog of a polycarboxylic acid; and

(b) at least one monohydroxy compound E of the formula (VII)

HO—[(R⁹O)ₓ—(R¹⁰O)_{y}—(R¹¹O)_{z}]—R^{12″} (VII)

and

(c) at least one monoamine compound F of the formula (VIII)

R^{7′}—NH—R^{8′} (VIII)

and optionally

(d) at least one further compound G.

Polycarboxylic acid or analog of a polycarboxylic acid is understood as meaning a homo- or copolymer which can be obtained by polymerization of at least one monomer a and optionally at least one monomer b. Monomer a is selected from the group consisting of unsaturated monocarboxylic acids, unsaturated dicarboxylic acids, analogs thereof and mixtures thereof. Unsaturated mono- or dicarboxylic acids preferably comprise maleic acid, itaconic acid, fumaric acid, citraconic acid, glutaconic acid, mesaconic acid or crotonic acid, in particular acrylic acid or methacrylic acid. An analog of a mono- or dicarboxylic acid or polycarboxylic acid is understood in the context of the present invention as meaning acid salts, acid halides, acid anhydrides and acid esters, in particular alkyl acid esters.

Monomer b is preferably selected from the group consisting of ethylenically unsaturated monomers comprising α,β-unsaturated mono- or dicarboxylic acids, α,β-unsaturated mono- or dicarboxylic acid esters, α,β-unsaturated carboxylates, styrene, ethylene, propylene, vinyl acetate, in particular methacrylic acid, acrylic acid, crotonic acid, itaconic acid, maleic acid, fumaric acid and salts, esters and mixtures thereof.

A copolymer of acrylic acid and methacrylic acid and salts or partial salts thereof are preferred as the copolymer.

Polymethacrylic acid or polyacrylic acid, in particular polymethacrylic acid, or salts or partial salts thereof are preferred as the homopolymer.

The polycarboxylic acid or the analog of the polycarboxylic acid may be present here as free acid or as a partial salt, the term “salt” comprising, here and below, not only the classical salts, as are obtained by neutralization with a base, but also complex chemical compounds between metal ions and the carboxylate or carboxyl groups as ligands. In the preparation of the polycarboxylic acid or of the analog of the polycarboxylic acid, any initiators, coinitiators and polymerization regulators used should optionally be chosen so that preferably no reactive hydroxyl or amine functions are present in the polymer P.

Here and below, “monohydroxy compound” is understood as meaning a substance which has only one free hydroxyl group.

Here and below, “monoamine compound” is understood as meaning a substance which has only one free amino group, or ammonia as a gas or as an aqueous solution.

In the context of the invention, “molecular weight” is understood as meaning the average molecular weight M_{w}.

Throughout the present document, “(meth)acrylic acid” is understood as meaning both acrylic acid and methacrylic acid.

The homo- or copolymer of the polycarboxylic acid or of the analog of the polycarboxylic acid is obtained by a free radical polymerization by customary processes. It can be effected in a solvent, preferably in water, or in the absence of a solvent. This free radical polymerization is preferably effected in the presence of at least one molecular weight regulator, in particular an inorganic or organic sulfur compound, such as, for example, mercaptans, or a phosphorus compound. The polymerization is advantageously effected under conditions such that the homo- or copolymer formed is composed of from 10 to 250, preferably from to 100, more preferably from 25 to 60, monomer building blocks. Such homo- or copolymers of (meth)acrylic acid are commercially available. The homo- or copolymer of the polycarboxylic acid or of the analog of the polycarboxylic acid preferably has a molecular weight M_{w} of from 500 to 20 000 g/mol, preferably from 2000 to 10 000 g/mol, particularly preferably from 3500 to 6500 g/mol.

The monohydroxy compound E is preferably terminated at one end with terminal groups which are not reactive under customary reaction conditions. This polymer is preferably a polymer having a polyalkylene glycol skeleton. The monohydroxy compound E has the formula (VII)

HO—[(R⁹O)ₓ—(R¹⁰O)_{y}—(R¹¹O)_{z}]—R^{12″} (VII)

in which R⁹, R¹⁰ and R¹¹, each independently of one another, is a C₂-C₄-alkylene group, with an order of the (R⁹O), (R¹⁰O) and (R¹¹O) units in any possible sequence; in which R^{12″} is a C₁-C₁₂-alkyl or cycloalkyl radical, a C₇-C₂₀-alkylaryl or aralkyl radical, or a substituted or unsubstituted aryl radical; and in which x, y and z, independently of one another, each have the values 0-250 and x+y+z=3-250.

Preferred monohydroxy compounds E of the formula (VII) are those having a methyl, ethyl, isopropyl or n-butyl group, in particular having a methyl group, as substituent R^{12″} and having z=0. Preferably, R⁹, independently of one another, is a C₂-alkylene group and R¹⁰, independently of one another, is a C₃-alkylene group. E preferably comprises copolymers of ethylene oxide/propylene oxide, more preferably polyethylene glycol endcapped at one end.

Mixtures of a plurality of different compounds of group E are likewise possible. Thus, for example, polyethylene glycols endcapped at one end and having different molecular weights can be mixed, or, for example, mixtures of polyethylene glycols endcapped at one end with copolymers of ethylene oxide and propylene oxide which are endcapped at one end or polypropylene glycols endcapped at one end can be used.

In the context of the invention, “terminated with terminal groups which are not reactive under customary reaction conditions” is understood as meaning that, instead of functional groups reactive for the esterification or amidation, groups which are no longer capable of reaction are present. The customary reaction conditions are those which are familiar to the person skilled in the art for esterifications and amidations. In the case of compounds “terminated at one end”, only one end is no longer reactive.

In a preferred embodiment, the monohydroxy compounds E is a polyalkylene glycol endcapped at one end and having a molecular weight M_{w} of from 300 to 10 000 g/mol, in particular from 500 to 5000 g/mol, preferably from 800 to 3000 g/mol. A mixture of polyalkylene glycols endcapped at one end and having different molecular weights is also particularly suitable, for example the mixture of polyalkylene glycols having a molecular weight of 1000 g/mol with polyalkylene glycols having a molecular weight of 3000 g/mol.

In addition to the monohydroxy compound E, a monoamine compound F is used in the first and, if appropriate, in the second process. This results in the formation of amide groups in addition to the formation of ester groups. If the preparation of the polymer P is effected by the first process by the so-called polymer-analogous reaction, the monoamine compound F preferably has a boiling point and flashpoint which is higher than the reaction temperature of the polycarboxylic acid with the monohydroxy compound E. Furthermore, the monoamine compound F preferably contains no hydroxyl groups.

Typical examples of such monoamine compounds F can be represented by the formula (VIII)

R^{7′}—NH—R^{8′} (VIII)

Firstly, R^{7′} and R^{8′} can together form a ring which optionally contains oxygen, sulfur or further nitrogen atoms.

Examples of such monoamine compounds F are in particular 9H-carbazole, indoline or imidazole.

Secondly, R^{7′} and R^{9′}, independently of one another, may be H, a C₈-C₂₀-alkyl group, a C₅-C₉-cycloalkyl group, a C₇-C₁₂-aralkyl group or a compound of the formula (IV), (V) or (VI).

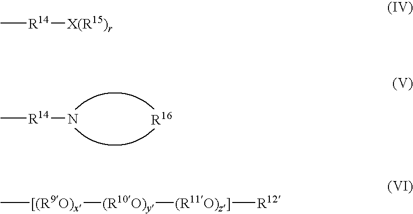

Here, R¹⁴, independently of one another, is an alkylene group, preferably a C1- to C4-alkylene group, and R¹⁵ is a C₁- to C₄-alkyl group. X, independently of one another, is an S, O or N, where r=1 if X═S or O and r=2 if X═N. R¹⁶ is an alkylene group having optionally heteroatoms and forms a 5-membered to 8-membered ring, in particular a 6-membered ring, with the nitrogen atom.

The substituents R^{9′}, R^{10′}, R^{11′}, and R^{12′} or the indices x′, y′ and z′, independently of one another, have the same meanings as have already been defined for R⁹, R¹⁰, R¹¹ and R¹² or x, y and z of the formula (VII).

Examples of such monoamine compounds F are dioctylamine, distearylamine, di-tallow fatty amine, fatty amines such as stearylamine, coconut fatty amine, octadecylamine, tallow fatty amine, oleylamine; 3-butoxypropylamine, bis(2-methoxyethyl)amine; α-meth-oxy-ω-aminopolyoxyethylene, α-methoxy-ω-aminopolyoxy-propylene, α-methoxy-ω-aminooxyethylene-oxypropylene copolymer.

Preferably, the monoamine compound F is a primary monoamine. α-Methoxy-ω-aminooxyethylene-oxypropylene copolymers, such as, for example, Jeffamin® M-2070, or α-methoxy-ω-aminopolyoxyethylenes, and other monoamines which are sold, for example, by Huntsman under the name Jeffamin® of the M series, and mixtures thereof are particularly preferred as monoamine compounds F. In general, α-methoxy-ω-aminooxyethylene-oxypropylene copolymers are preferred. Such monoamine compounds F are obtainable, for example, from an alcohol-initiated polymerization of ethylene oxide and/or propylene oxide, followed by conversion of the terminal alcohol group into an amine group.

A preferred further compound G is a compound which can undergo a reaction with the polycarboxylic acid or the analog of the polycarboxylic acid. Examples of compound G are further amines or alcohols, for example a C₆-C₂₀-alkyl alcohol or a further mono- or diamine. It is also possible to use a plurality of different compounds G.

The reaction of the polycarboxylic acid or the analog of the polycarboxylic acid with at least one monohydroxy compound E and with at least one monoamine compound F and optionally a compound G to give a polymer P is effected in the polymer-analogous reaction typically by a procedure in which the at least one monohydroxy compound E is added to the polycarboxylic acid or the analog of the polycarboxylic acid with stirring and is heated to the reaction temperature. The mixture is further stirred at the reaction temperature described above and is reacted possibly in vacuo or by passing a gas stream over or through the reaction mass. The temperature for this reaction is, for example, from 140° C. to 200° C. However, the reaction is also possible at temperatures from 150° C. to 175° C. If a monoamine compound F is used, the addition thereof can be effected simultaneously with the monohydroxy compound E or at a later time during this reaction step.

In a preferred embodiment, this reaction is carried out in the presence of an esterification catalyst, in particular of an acid. Such an acid is preferably sulfuric acid, p-toluenesulfonic acid, benzenesulfonic acid, methanesulfonic acid, phosphoric acid or phosphorous acid. Sulfuric acid is preferred. The removal of the water from the reaction mixture can be effected under atmospheric pressure or in vacuo. It is also possible to pass a gas stream over or through the reaction mixture. The gas stream used may be air or nitrogen.

The reaction can be monitored by means of measurement of the acid number, for example by titration, and can be stopped at a desired acid number so that the desired ratio of carboxylic acid to ester or amide groups is achieved. The reaction is terminated by eliminating the vacuum and cooling.

In a preferred embodiment, a polymethacrylic acid is esterified with a polyethylene glycol, which is terminated at one end with a methoxy group, and reacted with a monoamine, in particular a polyethermonoamine.

In a second process, in a first step according to the so-called polymer-analogous reaction, anhydride groups are also formed in addition to ester groups and optionally amide groups and, in a second step, the anhydride groups formed in the first step are reacted completely or partially with an amine compound to give an amide. Such processes are described, for example, in WO2005/090416A1.

The first step is preferably effected as in the preparation process described for the polymer-analogous reaction.

If amine compounds are already used in the first step of the second process, in particular amine compounds as described for the monoamine compound F are preferred.

In this case, the monoamine compound F has a boiling point and flashpoint which is higher than the reaction temperature of the first step. Furthermore, the monoamine compound F must not contain any hydroxyl groups.

Preferably, no amines are used in the first step.

In a second step of the second process, the polymer which is formed in the first step and has anhydride groups in addition to ester groups and optionally amide groups is reacted with an amine compound F′ at temperatures below 60° C., preferably below 40° C. The reaction is preferably effected at from 10° C. to 60° C., particularly preferably from 15 to 40° C., more preferably from 20 to 30° C. This reaction can be realized under mild conditions and requires no vacuum, so that it is also possible to use amine compounds F′ having a low boiling point or amine compounds F′ which also contain hydroxyl groups in addition to the amino group.

If the preparation of the polymer P is effected by this second process, typical examples of suitable amine compounds F′ for the second step can be represented by the formula (VIII′)

R^{7″}—NH—R^{8″} (VIII′)

Firstly, R^{7″} and R^{8″} together may form a ring which optionally contains oxygen, sulfur or further nitrogen atoms.

Examples of such amine compounds F′ are in particular 9H-carbazole, indoline, piperidine, morpholine, pyrrolidine, 1,3-thiazolidine, 2,3-dihydro-1,3-thiazole, imidazole. Morpholine is particularly suitable.

Secondly, R^{7″} and R^{8″}, independently of one another, may be H, a C₁-C₁₂-alkyl group, a C₅-C₉-cycloalkyl group, a C₇-C₁₂-aralkyl group, a hydroxyalkyl group, in particular —CH₂CH₂—OH or —CH₂CH(OH)CH3, or a compound of the formula (IV), (V) or (VI).

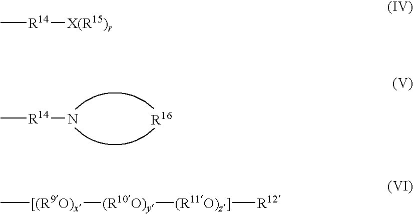

Here, R¹⁴, independently of one another, is an alkylene group, preferably a C1- to C4-alkylene group, and R¹⁵ is a C₁- to C₄-alkyl group. X, independently of one another, is an S, O or N, where r=1 if X═S or O and r=2 if X═N. R¹⁶ is an alkylene group having optionally heteroatoms and, together with the nitrogen atom, forms a 5-membered to 8-membered ring, in particular a 6-membered ring.

The substituents R^{9″}, R^{10′}, R^{11′} and R^{12′} or the indices x′, y′ and z′, independently of one another, have the same meanings as have already been defined for R⁹, R¹⁰, R¹¹ and R¹² or x, y and z of the formula (VII).

A preferred hydroxyalkyl group is the group —CH₂CH₂—OH or —CH₂CH (OH)CH₃.

Suitable amine compounds F′ are, for example, ammonia, butylamine, hexylamine, octylamine, decylamine, diethylamine, dibutylamine, dihexylamine, cyclopentyl-amine, cyclohexylamine, cycloheptylamine and cyclo-octylamine, dicyclohexylamine; 2-phenylethylamine, benzylamine, xylylamine; N,N-dimethylethylenediamine, N,N-diethylethylenediamine, 3,3′-iminobis(N,N-dimethyl-propylamine), N,N-dimethyl-1,3-propanediamine, N,N-diethyl-1,3-propanediamine, N,N,N′-trimethylethylenediamine, 2-methoxyethylamine, 3-methoxypropylamine; ethanolamine, isopropanolamine, 2-aminopropanol, diethanolamine, diisopropanolamine, N-isopropylethanolamine, N-ethylethanolamine, N-butylethanolamine, N-methylethanolamine, 2-(2-aminoethoxy)ethanol; 1-(2-aminoethyl)piperazine, 2-morpholinoethylamine, 3-morpholinopropylamine.

Particularly preferred is the amine compound F′ selected from the group consisting of morpholine, 2-morpholin-4-ylethylamine, 2-morpholin-4-ylpropylamine, N,N-dimethylaminopropylamine, ethanolamine, diethanolamine, 2-(2-aminoethoxy)ethanol, dicyclohexylamine, benzylamine, 2-phenylethylamine, N-(2-hydroxyethyl)ethylenediamine, and other amines which are sold, for example, by Huntsman under the name Jeffamine®, and mixtures thereof.

In a preferred embodiment, a polymethacrylic acid is esterified with a polyethylene glycol, which is terminated at one end with a methoxy group, and then reacted under mild conditions with mono- or diethanolamine.

In a third preparation process, the polymer P is prepared via free radical polymerization. The route via free radical polymerization is the most customary method but is complicated in the case of specific compounds by the commercial availability of the corresponding monomers and requires a complicated process control.

The invention therefore additionally relates to the use of a polymer P as a dispersant, in particular as a plasticizer, for gypsum compositions, the polymer P being obtainable by the polymerization reaction, in the presence of at least one free radical former, of

(a) at least one ethylenically unsaturated mono- or dicarboxylic acid M or an analog of an unsaturated mono- or dicarboxylic acid; with

(b) at least one ethylenically unsaturated carboxylic acid derivative H of the formula (IX);

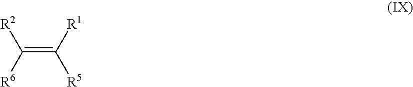

and

(c) at least one second ethylenically unsaturated carboxylic acid derivative K of the formula (X);

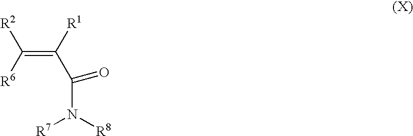

and optionally

(d) at least one further ethylenically unsaturated compound L.

The substituents R¹, R², R³, R⁵, R⁶, R⁷ and R⁸, independently of one another, each have the same meanings as have already been described for the formula (II) or (III).

The ethylenically unsaturated mono- or dicarboxylic acid M or the analog of the unsaturated mono- or dicarboxylic acid is preferably maleic acid, itaconic acid, fumaric acid, citraconic acid, glutaconic acid, mesaconic acid or crotonic acid, in particular acrylic acid or methacrylic acid. Methacrylic acid is particularly preferred. In the context of the present invention, analog of a mono- or dicarboxylic acid is understood as meaning acid salts, acid halides, acid anhydrides and acid esters, in particular alkyl acid esters.

The at least one ethylenically unsaturated carboxylic acid derivative H of the formula (IX) is preferably a carboxylic acid ester, particularly preferably an acrylic acid ester or a methacrylic acid ester. Examples of such esters are polyalkylene glycol(meth)acrylates. It is possible to use a plurality of monomers of the formula (IX) having different substituents R⁵ in combination with one another. For example, the joint use of polyalkylene glycols, in particular of polyethylene glycols, having different molecular weights is preferred.

The second ethylenically unsaturated carboxylic acid derivative K of the formula (X) is a carboxamide. Amides of ethylenically unsaturated mono- or dicarboxylic acids with amine compounds F′ of the formula (VIII′), in particular of monoamine compounds F of the formula (VIII), can be used as suitable carboxamides. Particularly preferred are amides of (meth)acrylic acid, preferably the polyoxyalkylene monoamides. Particularly preferred amide monomers are the alkylpolyalkylene glycol(meth)acrylamides, particularly preferably the methylpolyethylene glycol(meth)acrylamides, the methylpolyethylene glycol polypropylene glycol(meth)acrylamides or the methylpolypropylene glycol(meth)acrylamides. Examples of unsaturated carboxamides of amines of the formula (VIII′) are preferably mono- or dihydroxyethyl(meth)acrylamide, mono- or dihydroxypropyl(meth)acrylamide, mono- or dicyclohexyl(meth)acrylamide or N-alkyl, —N-hydroxyethyl(meth)acrylamides or N-alkyl, —N-hydroxypropyl(meth)acrylamides.

One or more of these unsaturated carboxamides may be used.

For the use according to the invention, the polymer P can be used both in liquid and solid form, both alone or as a constituent of a dispersant, in particular of a plasticizer.

For the use according to the invention, the polymer P can therefore be used, as a single polymer P or as mixtures of a plurality of polymers P, as a dispersant for gypsum compositions. However, polymers P can also be used with other dispersants or dispersant mixtures. For the use according to the invention, the polymers P or mixtures which contain the polymers P can contain further constituents. Examples of further constituents are solvents or additives, such as other plasticizers, for example lignosulfonates, sulfonated naphthaleneformaldehyde condensates, sulfonated melamineformaldehyde condensates or polycarboxylate ethers (PCE), accelerators, retardants, shrinkage reducers, antifoams or foam formers.

Depending on preparation process or reaction procedure, the dispersant may also contain, in addition to polymer P, free compounds of the starting materials, in particular free monohydroxy compounds, such as, for example, polyalkylene glycol, in particular free polyethylene glycol.

If the polymer P is used in liquid form, a solvent is preferably used for the reaction. Preferred solvents are, for example, hexane, toluene, xylene, methylcyclohexane, cyclohexane or dioxane, and alcohols, in particular ethanol or isopropanol, and water, water being the most preferred solvent.

The polymer P may also be present in the solid state of aggregation. In the context of the invention, polymers in the solid state of aggregation are understood as meaning polymers which are present at room temperature in the solid state of aggregation and, for example, are powders, scales, pellets, granules or sheets and can be transported and stored in this form without problems.

If, according to the second process, the amine is added only in a second step, for example, the amine can be initially introduced in a solvent, preferably water, and the product from the first reaction step can be added as a polymer melt or in solid form, for example as powder or in the form of scales or of granules with stirring. With the use of solvents in the second stage, it is possible, if desired, to remove the solvent again, for example by applying a vacuum and/or by heating, or further dilution can be effected. It is also possible for the amine, too, to be present in the solid state of aggregation or in or on a carrier material.

The polymer P is preferably used in an amount of from 0.01 to 10% by weight, based on the weight of the binder, in order to achieve the desired effect in the gypsum composition. It is also possible to use a plurality of polymers P as a mixture in order to achieve the desired effect.

In a further aspect, the present invention relates to a binder-containing mixture comprising gypsum and at least one polymer P. The polymer P has already been described above.

The term “gypsum” covers any known form of gypsum, in particular calcium sulfate dihydrate, calcium sulfate α-hemihydrate, calcium sulfate β-hemihydrate or calcium sulfate anhydrite.

The binder-containing mixture contains at least 30% by weight, preferably at least 50% by weight, most preferably at least 80% by weight, of gypsum, based on the total weight of the binder. The binder may contain further hydraulically setting substances, such as, for example, cement, in particular Portland cements or high-alumina cements, and respective mixtures thereof with fly ashes, silica fume, slag, blast furnace sands and limestone filler or quicklime.

Furthermore, the mixture may contain further aggregates, such as sand, gravel, stones, quartz powder, chalks, and constituents customary as additives, such as other plasticizers, for example lignosulfonates, sulfonated naphthalene-formaldehyde condensates, sulfonated melamine-formaldehyde condensates or polycarboxylate ethers (PCE), accelerators, retardants, shrinkage reducers, antifoams or foam formers.

In a further aspect, the present invention relates to a process for the preparation of a binder-containing mixture, the at least one polymer P being added separately or premixed as an admixture in solid or liquid form to the binder.

The addition of the polymer P in solid form is particularly suitable. Thus, the polymer P in the solid state of aggregation may be a constituent of a gypsum composition, a so-called dry blend, which has a relatively long shelf-life and is typically packed in bags or stored in silos and used in said form. Such a dry blend may also be used after a relatively long storage time and has good flowability.

The polymer P can also be added to a customary gypsum composition with or shortly before or shortly after the addition of the water. The addition of the polymer P in the form of an aqueous solution or dispersion, in particular as mixing water or as part of the mixing water, has proven particularly suitable here. The preparation of the aqueous solution or dispersion is effected by addition of water during the preparation of the polymer P or by subsequent mixing of polymer P with water. Typically, the proportion of the polymer P is from 10 to 90% by weight, in particular from 20 to 50% by weight, based on the weight of the aqueous solution or dispersion. Depending on the type of polymer P, a dispersion or a solution forms. A solution is preferred.

The aqueous solution or dispersion may contain further constituents. Examples of these are solvents or additives, as are familiar in construction chemistry, in particular surface-active substances, heat and light stabilizers, dyes, antifoams, accelerators, retardants, foam formers.

The polymer P has particularly good properties as a dispersant, in particular as a plasticizer, for gypsum compositions, i.e. the resulting mixture has significantly greater flow behavior in comparison with a composition without the dispersant, without the solidification being substantially retarded. The flow behavior is typically measured via the slump. On the other hand, it is possible to obtain mixtures which require significantly less water for the same flow behavior, so that the mechanical properties of the hardened gypsum composition are greatly enhanced.

The polymer P as a dispersant, in particular as a plasticizer, therefore has outstanding properties in systems which predominantly contain sulfate binders. Moreover, compositions which do not become discolored are possible with the polymer P.

### Examples

The invention is illustrated in more detail with reference to examples.

1. Polymers P Used

TABLE 1
Abbreviations used.

| Abbreviation | Meaning | Mw* |
|---|---|---|
| PEG1000 | Polyethylene glycol without | 1000 g/mol |
| | terminal OH groups | |
| PEG3000 | Polyethylene glycol without | 3000 g/mol |
| | terminal OH groups | |
| EO/PO(70/30)2000 | Block copolymer of ethylene oxide | 2000 g/mol |
| | and propylene oxide in the ratio | |
| | 70:30 without terminal OH groups | |

*Mw = average molecular weight

The polymers P-1 and P-2 shown in Table 2 were prepared by means of polymer-analogous reaction from poly(meth)acrylic acid with the corresponding alcohols and amines in a known manner. Details of polymer-analogous reaction are disclosed, for example, in EP 1 138 697 B1, on page 7, line 20 to page 8, line 50, and in examples thereof or in EP 1 061 089 B1, on page 4, line 54 to page 5, line 38 and in examples thereof.

The polymer P-3 was prepared via free radical copolymerization, as described, for example, in EP 1 136 508 A1, for example in Example 1.

The Comparative Examples N-1 to N-5 were prepared in the same manner as the polymers P-1 and P-2.

Comparative Example N-6 is a commercially available plasticizer prepared on the basis of melamine (Melment® F15G from BASF).

TABLE 2
Polymers P-1, P-2 and P-3 according to the
invention or comparative polymers N-1 to N-5 correspond
to the formula (I), (II) or (III), respectively, where
R² = H, R³ = H, R⁶ = H, R⁷ = H, M = H⁺, Na⁺;

| | | | | | | | m/ |
|---|---|---|---|---|---|---|---|
| No. | R¹ | R¹³ | | R⁸ | Mol % | Mw | (n + o + p) |
| P-1 | —CH3 | -PEG1000-OCH3:- | 50:50* | -EO/PO(70/30)2000-OCH3 | m = 79.6 | 45 000 | 3.77 |
| | | PEG3000-OCH3 | | | n = 20.2 | | |
| | | | | | o = 0.2 | | |
| | | | | | p = 0 | | |
| P-2 | —CH3 | -PEG1000-OCH3:- | 45:55* | -EO/PO(70/30)2000-OCH3 | m = 74.5 | 60 000 | 2.95 |
| | | PEG3000-OCH3 | | | n = 25.3 | | |
| | | | | | o = 0.2 | | |
| | | | | | p = 0 | | |
| P-3 | —CH3 | -PEG1000-OCH3 | | -EO/PO(70/30)2000-OCH3 | m = 76.7 | 30 000 | 3.3 |
| | | | | | n = 23.1 | | |
| | | | | | o = 0.2 | | |
| | | | | | p = 0 | | |
| N-1 | —H | -PEG1000-OCH3 | | -EO/PO(70/30)2000-OCH3 | m = 59.8 | 25 000 | 1.5 |
| | | | | | n = 40 | | |
| | | | | | o = 0.2 | | |
| | | | | | p = 0 | | |
| N-2 | —CH3 | -PEG1000-OCH3 | | -EO/PO(70/30)2000-OCH3 | m = 63.8 | 35 000 | 1.87 |
| | | | | | n = 36 | | |
| | | | | | o = 0.2 | | |
| | | | | | p = 0 | | |
| N-3 | —H | -PEG1000-OCH3 | | -EO/PO(70/30)2000-OCH3 | m = 86.5 | 30 000 | 6.4 |
| | | -PEG3000-OCH3 | | | n = 13.3 | | |
| | | | | | o = 0.2 | | |
| | | | | | p = 0 | | |
| N-4 | —CH3 | -PEG3000-OCH3 | | -EO/PO(70/30)2000-OCH3 | m = 86.5 | 35 000 | 6.4 |
| | | | | | n = 13.3 | | |
| | | | | | o = 0.2 | | |
| | | | | | p = 0 | | |
| N-5 | —CH3 | -PEG1000-OCH3:- | | -EO/PO(70/30)2000-OCH3 | m = 64 | 72 000 | 1.86 |
| | | PEG3000-OCH3 | | | n = 35.8 | | |
| | | | | | o = 0.2 | | |
| | | | | | p = 0 | | |

*denotes molar ratio of the various R¹³ side chains

2.1 Flow Behavior in Pure Gypsum Compositions

A gypsum composition having a water/solids ratio of 0.24 was prepared with 65% by weight of calcium sulfate α-hemihydrate, 31.7% by weight of quartz sand having a grain size of 0-0.4 mm, and a plasticizer in the amount defined according to Table 3. The plasticizer was added simultaneously with the addition of the mixing water. In addition, the dry gypsum mortar mix contains additives, such as antifoam, thickener, dispersion powder and stabilizer. The % by weight are based in each case on the total weight of the dry gypsum mortar mix. The stated percentages by weight of the plasticizer relate in each case to the solids content of the polymers P or of the plasticizers, based on the total weight of the dry gypsum mortar mix (without water).

For investigating the flow behavior, the slump (SL) in millimeters after 3 minutes (min) and 20 minutes was determined. The investigations were carried out according to EN 196-1, EN 459-2, EN 13454-1 and 2. Moreover, the initial setting time (S-initial) and the final setting time (S-final) were measured using a Vicat needle apparatus according to DIN 1168.

TABLE 3
Slump (SL) in mm and initial/final setting
time in hours (h) and minutes (min)

| | | | | |
|---|---|---|---|---|
| Dose | S-initial | S-final | SL | SL |
| (% by weight) | (h:min) | (h:min) | 3 min | 20 min |

| | | | | | |
|---|---|---|---|---|---|
| P-1 | 0.15 | 0:39 | 0:45 | 370 | 342 |
| P-2 | 0.15 | 0:31 | 0:35 | 338 | 303 |
| P-3 | 0.15 | 0:33 | 0:38 | 344 | 308 |
| N-1 | 0.15 | 1:10 | 1:21 | 302 | 317 |
| N-2 | 0.15 | 0:41 | 0:48 | 322 | 314 |
| N-3 | 0.15 | 25:35 | 27:10 | 400 | 401 |
| N-4 | 0.15 | 1:31 | 1:42 | 402 | 397 |
| N-6 | 1.00 | 0:36 | 0:42 | 342 | 304 |

Table 3 shows that the processability of the gypsum compositions which contain the polymers P-1 to P-3 according to the invention is very good, without being delayed. In the case of the conventional plasticizers, either the initial setting time or the final setting time is greatly delayed (N-1, N-3, N-4) or the processability is poorer (N-1, N-2). The gypsum composition is considered to be readily processable if the values of the slump after 3 min are above 330 mm. In particular, a setting time, i.e. an initial or final setting time, of less than one hour is desired.

Moreover, the use of polymers N-1 leads to undesired postplasticization.

Table 3 also shows that, in a lower dose, the polymers used according to the invention achieve results comparable with those of conventional melamine-based gypsum plasticizers (N-6) without having the disadvantages thereof, such as, for example, formaldehyde release or discoloration. This means that, in order to obtain comparable results, the plasticizer N-6 must be used in a much higher dose.

2.2 Flow Behavior in Ternary Systems

A ternary composition having a water/solids ratio of 0.24 was prepared with 28% by weight of binder, of which 8% by weight are calcium sulfate α-hemihydrate, 14% by weight are high-alumina cement and 6% by weight are Portland cement (CEM I), 68.5% by weight of quartz sand having a grain size of 0-0.4 mm, and 0.2% by weight of plasticizer (Table 4). The % by weight are based in each case on the total weight of the dry mortar mix. In addition, the dry mortar mix contains additives, such as antifoam, thickener, dispersion powder and stabilizer.

For investigating the flow behavior, the slump (SL) in millimeters after 3 minutes (min) and 20 minutes was measured. The investigations were carried out according to EN 196-1, EN 459-2, EN 13454-1 and 2.

TABLE 4
Slump (SL) in mm

| | Dose (% by | | |
|---|---|---|---|
| | weight) | SL 3 min | SL 20 min |
| P-2 | 0.20 | 361 | 359 |
| P-3 | 0.20 | 355 | 360 |
| N-1 | 0.20 | 309 | 397 |
| N-2 | 0.20 | 343 | 326 |
| N-5 | 0.20 | 292 | 283 |
| N-6 | 0.60 | 315 | |

Table 4 shows that the processability of the gypsum compositions which, according to the invention, contain the polymers P-2 and P-3 is very good. In the case of the conventional plasticizers, the slump and hence the processability are lower (N-1, N-2, N-5, N-6). Moreover, here too the undesired postplasticization is evident with the use of polymers N-1.

Table 4 also shows that the conventional melamine-based gypsum plasticizer (N-6) does not achieve the slump of the polymers P-2 and P-3 used according to the invention, in spite of three times the dose.

2.3 Flow Behavior in Calcium Sulfate α-hemihydrate

For a gypsum slurry, the plasticizer was added in an amount defined according to Table 5 to 200 g of water, 500 g of calcium sulfate α-hemihydrate were then sprinkled in and stirring was effected for 1 minute at 1000 rpm. The slump was determined after 2 minutes using a minicone having a diameter of 50 mm and height of 51 mm. Using the Vicat needle apparatus according to DIN 1168, the initial setting time (S-initial) was determined according to EN 13279-2. The final setting time (S-final) is reached when the depth of penetration of the penetration cone into the gypsum cake is <1 mm.

TABLE 5
Slump (SL) in mm and initial/final setting
time in hours (h) and minutes (min)

| | Dose (% by | S-initial | S-final | SL |
|---|---|---|---|---|
| | weight) | (h:min) | (h:min) | 2 min |
| None | | 0:14 | 0:19 | 120 |
| P-1 | 0.1 | 0:23 | 0:26 | 219 |
| P-2 | 0.1 | 0:22 | 0:24 | 219 |
| P-3 | 0.1 | | | 230 |
| N-1 | 0.1 | 0:44 | 0:48 | 176 |
| N-2 | 0.1 | 0:30 | 0:33 | 201 |
| N-4 | 0.1 | 0:51 | 0:56 | 302 |
| N-5 | 0.1 | 0:43 | 0:50 | 225 |
| N-6 | 0.3 | 0:28 | 0:31 | 217 |

Table 5 shows that, in the pure gypsum slurry comprising calcium sulfate α-hemihydrate, the processability of the gypsum compositions which, according to the invention, contain the polymers P-1, P-2 and P-3 is very good without being delayed. In the case of the conventional plasticizers, either the slump and hence the processability are lower (N-1 and N-2) or the initial setting time or the final setting time is greatly delayed (N-1, N-2, N-4, N-5). If the gypsum slurry is prepared without plasticizer, the slump is substantially poorer.

Table 5 also shows that the conventional melamine-based gypsum plasticizer (N-6) does not achieve the results of the polymers P-1, P-2 and P-3 used according to the invention, in spite of three times the dose.

2.4 Flow Behavior in Calcium Sulfate β-hemihydrate

For a gypsum slurry, 204 g of water were initially introduced with the plasticizer in a dose shown according to Table 6, 300 g of calcium sulfate (3-hemi-hydrate were then sprinkled in within 15 seconds and the gypsum slurry was allowed to age for 30 seconds. Thorough stirring was then effected manually for 1 minute. The minicone having a diameter of 50 mm and a height of 51 mm was filled and the slump (SL) was determined after 2 minutes. Using the Vicat needle apparatus according to DIN 1168, the initial setting time (S-initial) was determined according to EN 13279-2. The final setting time (S-final) is reached when the depth of penetration of the penetration cone into the gypsum cake is <1 mm.

TABLE 6
Slump (SL) in mm and initial/final setting
time in minutes (min) and seconds (sec)

| | Dose (% by | S-initial | S-final | SL |
|---|---|---|---|---|
| | weight) | (min:sec) | (min:sec) | 2 min |
| None | | 5:30 | 7:40 | 215 |
| P-1 | 0.3 | 6:10 | 8:35 | 252 |
| P-2 | 0.3 | 6:35 | 9:05 | 254 |
| P-3 | 0.3 | 6:25 | 8:55 | 250 |
| N-1 | 0.3 | 9:50 | 15:10 | 252 |
| N-3 | 0.3 | 14:30 | 22:00 | 275 |
| N-4 | 0.3 | 7:35 | 10:30 | 258 |
| N-5 | 0.3 | 8:15 | 11:20 | 252 |
| N-6 | 0.3 | 5:00 | 6:35 | 236 |
| N-6 | 0.9 | 5:40 | 7:55 | 258 |

Table 6 shows that, in the pure gypsum slurry comprising calcium sulfate β-hemihydrate, the processability of the gypsum compositions which, according to the invention, contain the polymers P-1, P-2 and P-3 is very good and the initial setting time or the final setting time occurs substantially earlier than in the case of the conventional plasticizers. In the case of the conventional plasticizers, in particular the initial setting time and the final setting time are delayed (N-1, N-3, N-4, N-5) compared with the polymers used according to the invention.

The conventional melamine-based gypsum plasticizers (N-6) have the slump achieved with the polymers P-1, P-2 and P-3 used according to the invention only with three times the dose.

Of course, the invention is not limited to the working examples shown and described. It is clear that the abovementioned features of the invention can be used not only in the combination stated in each case but also in other modifications, combinations and amendments or in isolation without departing from the scope of the invention.

1. A method for preparing gypsum compositions, the method comprising:
adding at least one polymer P as a dispersant to a gypsum composition, the polymer P comprising:
a) m mol % of at least one structural unit A of the formula (I); 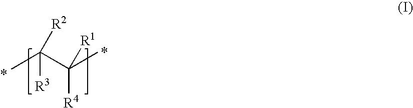
b) n mol % of at least one structural unit B of the formula (II); 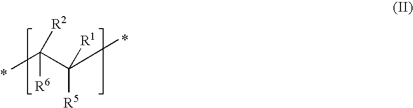
c) o mol % of at least one structural unit C of the formula (HI); 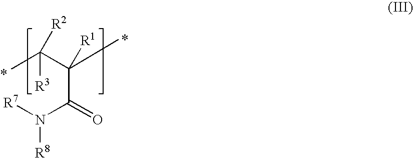
and optionally
d) p mol % of at least one further structural unit D;
in which R¹, independently of one another, is H, CH₂COOM or an alkyl group having 1 to 5 carbon atoms,
in which R², independently of one another, is H, an alkyl group having 1 to 5 carbon atoms, COOM or CH₂COOM;
in which R³, independently of one another, is H, CH₃, COOM or CH₂COOM; and
in which R⁴, independently of one another, is COOM;
or in which R³ and R⁴ form a ring to give —CO—O—CO—;
in which M is H, alkali metal, alkaline earth metal, ammonium, ammonium cation or mixtures thereof;
in which R⁵, independently of one another, is 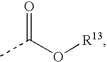
in which R¹³ is —[(R⁹O)ₓ—(R¹⁰O)_{y}—(R¹¹—O)_{z}]—R¹²;
in which R⁹, R¹⁰ and R¹¹, each independently of one another, is a C₂-C₄-alkylene group having an order of the (R⁹O), (R¹⁰O) and (R¹¹O) units in any possible sequence;
in which R¹² is H, a C₁-C₁₂-alkyl or cycloalkyl radical, a C₇-C₂₀-alkylaryl or aralkyl radical, or a substituted or unsubstituted aryl radical;
in which x, y and z, independently of one another, each have the values 0-250 and x+y+z=3-250;
in which R⁶, independently of one another, is H, CH₃, COOM, CH₂COOM or a substituent as defined for R⁵;
in which R⁷ and R⁸, together form a ring which optionally contains oxygen, sulfur or further nitrogen atoms;
or in which R⁷ and R⁸, independently of one another, are H, a C₁-C₂₀-alkyl group, a C₅-C₉-cycloalkyl group, a C₇-C₁₂-aralkyl group, a hydroxyalkyl group, or a compound of the formula (IV), (V) or (VI), 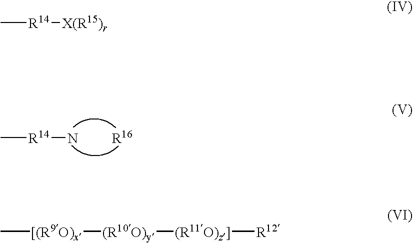
in which R¹⁴, independently of one another, is an alkylene group and R¹⁵ is a C₁- to C₄-alkyl group and X, independently of one another, is an S, O or N, where r=1 if X═S or O, or r=2 if X═N;
in which R¹⁶ is an alkylene group having optionally heteroatoms;
in which R^{9′}, R^{10′} and R^{11′}, each independently of one another, is a C₂-C₄-alkylene group having an order of the (R^{9′}O), (R^{10′}O) and (R^{11′}O) units in any possible sequence;
in which R^{12′} is a C₁-C₁₂-alkyl or cycloalkyl radical, a C₇-C₂₀-alkylaryl or aralkyl radical, or a substituted or unsubstituted aryl radical;
in which x′, y′ and z′, independently of one another, each have the values 0-100 and x′+y′+z′=1-100;
in which m, n, o and p, independently of one another, are numbers, where the sum m+n+o+p=100 and m>0, n>0, o>0 and p≧0; and in which the ratio m/(n+o+p) is from 2 to 6.

2. The method as claimed in claim 1, wherein the gypsum composition contains at least 30% by weight of gypsum, based on the total weight of the gypsum composition.

3. The method as claimed in claim 2, wherein the gypsum is calcium sulfate dihydrate, calcium sulfate hemihydrate or calcium sulfate anhydrite.

4. The method as claimed in claim 1, wherein the polymer P is obtained by or is prepared by means of polymer-analogous reaction of the esterification and amidation of a polycarboxylic acid.

5. The method as claimed in claim 4, wherein the polymer P obtained by reacting
a) at least one polycarboxylic acid or an analog of a polycarboxylic acid; and
b) at least one monohydroxy compound E of the formula (VII)
HO—[(R⁹O)ₓ—(R¹⁰O)_{y}—(R¹¹O)_{z}—R^{12″} (VII)
in which R⁹, R¹⁰ and R¹¹, each independently of one another, is a C₂-C₄-alkylene group, having an order of the (R⁹O), (R¹⁰O) and (R¹¹O) units in any possible sequence;
in which R^{12″} is a C₁-C₁₂-alkyl or cycloalkyl radical, a C₇-C₂₀-alkylaryl or aralkyl radical, or a substituted or unsubstituted aryl radical;
in which x, y and z, independently of one another, each have the values 0-250 and x+y+z=3 -250;
c) at least one monoamine compound F of the formula (VIII)
R^{7′}—NH—R^{8′} (VIII)
and/or at least one amine compound F′ of the formula (VIII′)
R^{7″}—NH—R^{8″} (VIII′)
in which R^{7′} and R^{8′} together form a ring which optionally contains oxygen, sulfur or further nitrogen atoms;
or in which R^{7′} and R^{8′}, independently of one another, are H, a C₈-C₂₀-alkyl group, a C₅-C₉-cycloalkyl group, a C₇-C₁₂-aralkyl group, or a compound of the formula (IV), (V) or (VI),
in which R^{7″} and R^{8″} together form a ring which optionally contains oxygen, sulfur or further nitrogen atoms;
or in which R^{7″} and R^{8″}, independently of one another, are H, a C₁-C₁₂-alkyl group, a C₅-C₉-cycloalkyl group, a C₇-C₁₂-aralkyl group, a hydroxyalkyl group, or a compound of the formula (IV), (V) or (VI), 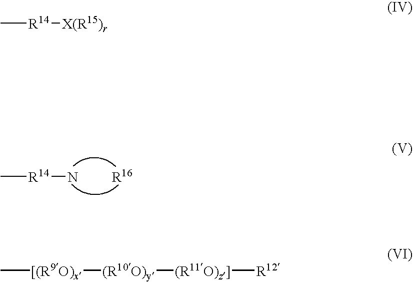
in which R¹⁴, independently of one another, is an alkylene group and R¹⁵ is a C₁- to C₄-alkyl group and X, independently of one another, is an S, O or N, where r=1 if X═S or O, and r=2 if X═N;
in which R¹⁶ is an alkylene group having optionally heteroatoms;
in which R^{9′}, R^{10′} and R^{11′}, each independently of one another, are a C₂-C₄-alkylene group having an order of the (R^{9′}O), (R^{10′}O) and (R^{11′}O) units in any possible sequence;
in which R^{12′} is a C₁-C₁₂-alkyl or cycloalkyl radical, a C₇-C₂₀-alkylaryl or aralkyl radical, or a substituted or unsubstituted aryl radical;
in which x′, y′ and z′, independently of one another, each have the values 0-100 and x′+y′+z′=1-100; and
optionally
d) at least one further compound G.

6. The method as claimed in claim 5, wherein at least one polycarboxylic acid or the analog of a polycarboxylic acid is reacted with at least one monohydroxy compound E of the formula (VII) and optionally at least one monoamine compound F of the formula (VTR) and optionally at least one further compound G at a temperature up to 200° C. so that anhydride groups form, and in that, in a second step, the anhydride groups formed in the first step are completely or partially converted into the amide with an amino compound F′ of the formula (VIII′) at temperatures substantially below 100° C.

7. The method as claimed in claim 5, wherein the analog of the polycarboxylic acid of the polymer P is selected from the group consisting of acid salts, acid halides, acid anhydrides and acid esters.

8. The method as claimed in claim 1, wherein the polymer P is obtained by or prepared by means of a free radical polymerization reaction.

9. The method as claimed in claim 8, wherein the polymer P is obtained by the polymerization reaction, in the presence of at least one free radical former, of
a) at least one ethylenically unsaturated mono- or dicarboxylic acid M or an analog of an unsaturated mono- or dicarboxylic acid; with
b) at least one ethylenically unsaturated carboxylic acid derivative H of the formula (IX); 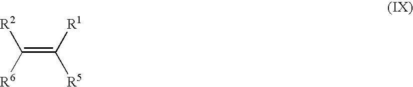
c) at least one second ethylenically unsaturated carboxylic acid derivative K of the formula (X) 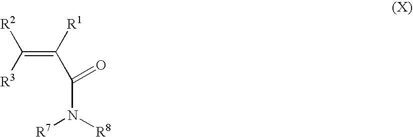
and optionally
d) at least one further ethylenically unsaturated compound L,
in which R¹, independently of one another, is H, CH₂COOM or an alkyl group having 1 to 5 carbon atoms,
in which R², independently of one another, is H, an alkyl group having 1 to 5 carbon atoms, COOM or CH₂COOM;
in which R³, independently of one another, is H, CH₃, COOM or CH₂COOM; and
in which M is H, alkali metal, alkaline earth metal, ammonium, ammonium cation or mixtures thereof;
in which R⁵, independently of one another, is 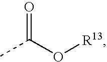
in which R¹³ is —[(R⁹O)ₓ—(R¹⁰O)_{y}—(R¹¹—O)_{z}]—R¹²;
in which R⁹, R¹⁰ and R¹¹ each independently of one another, is a C₂-C₄-alkylene group having an order of the (R⁹O), (R¹⁰O) and (R¹¹O) units in any possible sequence;
in which R¹² is H, a C₁-C₁₂-alkyl or cycloalkyl radical, a C₇-C₂₀-alkylaryl or aralkyl radical, or a substituted or unsubstituted aryl radical;
in which x, y and z, independently of one another, each have the values 0-250 and x+y+z=3-250;
in which R⁶, independently of one another, is H, CH₃, COOM, CH₂COOM or a substituent as defined for R⁵;
in which R⁷ and R⁸, together form a ring which optionally contains oxygen, sulfur or further nitrogen atoms;
or in which R⁷ and R⁸, independently of one another, are H, a C₁-C₂₀-alkyl group, a C₅-C₉-cycloalkyl group, a C₇-C₁₂-aralkyl group, a hydroxyalkyl group, or a compound of the formula (IV), (V) or (VI), 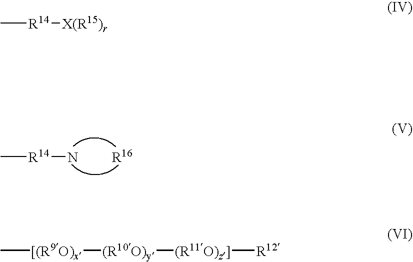
in which R¹⁴, independently of one another, is an alkylene group and R¹⁵ is a C₁- to C₄-alkyl group and X, independently of one another, is an S, O or N, where r=1 if X═S or O, or r=2 if X═N;
in which R¹⁶ is an alkylene group having optionally heteroatoms;
in which R^{9′}, R^{10′} and R^{11′}, each independently of one another, is a C₂-C₄-alkylene group having an order of the (R^{9′}O), (R^{10′}O) and (R^{11′}O) units in any possible sequence;
in which R^{12′} is a C₁-C₁₂-alkyl or cycloalkyl radical, a C₇-C₂₀-alkylaryl or aralkyl radical, or a substituted or unsubstituted aryl radical;
in which x′, y′ and z′, independently of one another, each have the values 0-100 and x′+y′+z′=1-100.

10. The method as claimed in claim 1, wherein, in the polymer P, R¹ is H or CH₃ and R², R³ and M are H.

11. The method as claimed in claim 1, wherein R⁶ is H.

12. The method as claimed in claim 1, wherein R⁹, independently of one another, is a C₂-alkylene group, R¹⁰, independently of one another, is a C₃-alkylene group and R¹¹, independently of one another, is a C₄-alkylene group, the order of (R⁹O), (R¹⁰O) and (R¹¹O) being random, alternating or blockwise.

13. The method as claimed in claim 12, wherein R¹³ comprises at least 30 mol % of (R⁹O) units, based on the total molar amount of all (R⁹O), (R¹⁰O) and (R¹¹O) units.

14. The method as claimed in claim 13, wherein R¹³ comprises 100 mol % of (R⁹O) units, based on the total molar amount of all (R⁹O), (R¹⁰O) and (R¹¹O) units.

15. The method as claimed in claim 1, wherein the polymer P comprises from 50 to 95 mol % of the structural unit A of the formula (I), from 5 to 50 mol %, of the structural unit B of the formula (II), from 0.001 to 30 mol % of the structural unit C of the formula (III), and optionally from 0 to 30 mol %, the structural unit D, based in each case on the total molar amount of the structural units of A, B, C and D in the polymer P.

16. The method as claimed in claim 1, wherein the polymer P has a molecular weight in the range of 1000-150 000 g/mol.

17. The method as claimed in claim 1, wherein the polymer P is in a liquid or solid form.

18. A binder-containing mixture comprising gypsum and at least one polymer P, the polymer P comprising:
a) m mol % of at least one structural unit A of the formula (I); 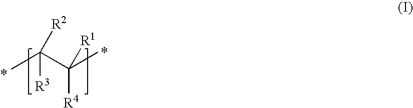
b) n mol % of at least one structural unit B of the formula (II); 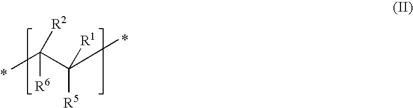
c) o mol % of at least one structural unit C of the formula (H); 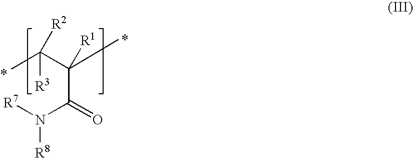
and optionally
d) p mol % of at least one further structural unit D;
in which R¹, independently of one another, is H, CH₂COOM or an alkyl group having 1 to 5 carbon atoms,
in which R², independently of one another, is H, an alkyl group having 1 to 5 carbon atoms, COOM or CH₂COOM;
in which R³, independently of one another, is H, CH₃, COOM or CH₂COOM; and
in which R⁴, independently of one another, is COOM;
or in which R³ and R⁴ form a ring to give —CO—O—CO—;
in which M is H, alkali metal, alkaline earth metal, ammonium, ammonium cation or mixtures thereof;
in which R⁵, independently of one another, is 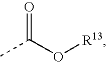
in which R¹³ is —(R⁹O)ₓ—(R¹⁰O)_{y}—(R¹¹—O)_{z}]—R¹²;
in which R⁹, R¹⁰ and R¹¹, each independently of one another, is a C₂-C₄-alkylene group having an order of the (R⁹O), (R¹⁰O) and (R¹¹O) units in any possible sequence;
in which R¹² is H, a C₁-C₁₂-alkyl or cycloalkyl radical, a C₇-C₂₀-alkylaryl or aralkyl radical, or a substituted or unsubstituted aryl radical;
in which x, y and z, independently of one another, each have the values 0-250 and x+y+z=3-250;
in which R⁶, independently of one another, is H, CH₃, COOM, CH₂COOM or a substituent as defined for R⁵;
in which R⁷ and R⁸, together form a ring which optionally contains oxygen, sulfur or further nitrogen atoms;
or in which R⁷ and R⁸, independently of one another, are H, a C₁-C₂₀-alkyl group, a C₅-C₉-cycloalkyl group, a C₇-C₁₂-aralkyl group, a hydroxyalkyl group, or a compound of the formula (IV), (V) or (VI) 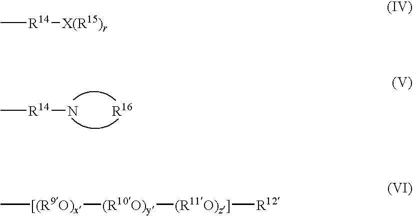
in which R¹⁴, independently of one another, is an alkylene group and R¹⁵ is a C₁- to C₄-alkyl group and X, independently of one another, is an S, O or N, where r=1 if X═S or O, or r=2 if X═N;
in which R¹⁶ is an alkylene group having optionally heteroatoms;
in which R^{9′}, R^{10′} and R^{11′}, each independently of one another, are a C₂-C₄-alkylene group having an order of the (R^{9′}O), (R^{10′}O) and (R^{11′}O) units in any possible sequence;
in which R^{12′} is a C₁-C₁₂-alkyl or cycloalkyl radical, a C₇-C₂₀-alkylaryl or aralkyl radical, or a substituted or unsubstituted aryl radical;
in which x′, y′ and z′, independently of one another, each have the values 0-100 and x′+y′+z′=1-100;
in which m, n, o and p, independently of one another, are numbers, where m+n+o+p=100 and m>0, n>0, o>0 and p≧0; and in which the ratio m/(n+o+p) is from 2 to 6.

19. The binder-containing mixture as claimed in claim 18, wherein the mixture contains at least 30% by weight of gypsum, based on the total weight of the binder.

20. The binder-containing mixture as claimed in claim 18, wherein the gypsum is calcium sulfate dihydrate, calcium sulfate hemihydrate or calcium sulfate anhydrite.

21. The binder-containing mixture as claimed in claim 18, wherein the polymer P is obtained by or is prepared by means of polymer-analogous reaction of the esterification and amidation of a polycarboxylic acid.

22. The binder-containing mixture as claimed in claim 18, wherein the polymer P is obtained by or is prepared by means of a free radical polymerization reaction.

23. A process for the preparation of a binder-containing mixture as claimed in claim 18, the process comprising: adding the polymer P separately, or premixed as an admixture, in solid or liquid form to the binder.
